(19) United States
(12) Patent Application Publication
(10) Pub. No.: US 2015/0047939 A1
(43) Pub. Date: Feb. 19, 2015

(54) SUITCASE WITH TELESCOPIC HANDLE DEVICE CAPABLE OF LOCATING CAMERA

(71) Applicant: Han-Hsiang Chang, Taoyuan Hsien (TW)

(72) Inventor: Han-Hsiang Chang, Taoyuan Hsien (TW)

(21) Appl. No.: 13/965,223

(22) Filed: Aug. 13, 2013

(51) Int. Cl. A45C 13/28; A45C 13/26; A45C 5/03; F16M 11/04; A45C 9/00

(52) U.S. Cl. CPC A45C 13/28; F16M 11/04; A45C 9/00; A45C 5/03; A45C 13/262
USPC 190/102

(57) ABSTRACT

A suitcase with a telescopic handle device capable of locating a camera includes a U shape handle with a camera locating unit for locating a camera. The camera locating unit has a driving shaft having a ball at one end thereof for combining to the U shape handle so that the driving shaft is rotatable multiple-directionally with respect to the U shape handle by using the ball as a fulcrum. A suitcase using the U shape handle is included. The U shape handle is telescopic with respect to the case of the suitcase. By the structures, no tripod is carried in travel. In taking pictures, it only needs to place a camera on the platform and the bag is placed to a desired location. Then the user can take pictures as desired.

### FIELD OF THE INVENTION

The present invention relates to handles for locating a camera, and in particular to a suitcase with a telescopic handle device capable of locating a camera.

### BACKGROUND OF THE INVENTION

Many people carry cameras in travelling for taking pictures. However, they often carry tripods for locating the cameras.

For long distance travels, usually travelers carry traveling bags or packsacks, however, cameras, tripods, and other equipments will increase burdens of the travelers. This is especially inconvenient for long term and long distance travel

Therefore, if traveling bags or packsacks can provide functions for locating the cameras or other related equipments, i. e., the traveling gags or packsacks having the function of tripod, not only money for buying tripods is saved, but also baggage of the traveler is reduced so that the traveler feels happy in traveling.

### SUMMARY OF THE INVENTION

Accordingly, to resolve above mentioned problem for travelers, the present invention provides a suitcase with a telescopic handle device capable of locating a camera. The object of the present invention is to install a U shape handle to a general used bags, such as travelling bags, packsacks, suitcases, etc., which the U shape handle has a function of locating a camera. Thus, by the present invention, no tripod is carried in travel. In capturing pictures, it only needs to place a camera on the platform and the bag is placed to a desired location. Then the user can take pictures as desired.

The present invention disclosed a suitcase with a telescopic handle device capable of locating a camera. The handle of the present invention includes a camera locating unit for locating a camera. Preferably, the handle has a U shape.

The camera locating unit has a driving shaft having a ball at one end thereof for combining to the handle so that the driving shaft is rotatable multiple-directionally with respect to the handle by using the ball as a fulcrum. A suitcase with the handle for locating a camera is also disclosed in the present invention. The handle is telescopic with respect to the case of the suitcase. The suitcase includes a case for locating objects; a telescopic handle installed in the case; the handle being holdable for driving the case to move and being as a tripod; and the handle being installed with a camera locating unit for locating a camera.

### BRIEF DESCRIPTION OF THE DRAWINGS:

FIG. 1 is a schematic view about the handle of the present invention.

FIG. 2 shows another schematic view of the handle of the present invention.

FIG. 3 is an exploded schematic view of the camera locating unit of the present invention.

FIG. 4 is a schematic view about the camera locating unit of the present invention.

FIG. 5 is an assembled schematic view about the camera locating unit and the handle of the present invention.

FIG. 6 is a schematic view showing the application of the present invention.

FIG. 7 is a schematic view showing the platform of the present invention.

FIG. 8 is a schematic view showing the retaining sheet of the present invention.

FIG. 9 is another schematic view about the camera locating unit of the present invention.

FIG. 10 is an assembled schematic view about showing another platform of the present invention.

FIG. 11 is an assembled view of the structure shown in FIG. 10.

FIG. 12 shows the usage of the camera locating unit of the present invention.

FIG. 13 shows another usage of the camera locating unit of the present invention.

FIG. 14 shows a further usage of the camera locating unit of the present invention.

FIG. 15 shows a still usage of the camera locating unit of the present invention.

FIG. 16 shows a yet usage of the camera locating unit of the present invention.

FIG. 17 shows the structure of the present invention, in that a suitcase is installed with a U shape handle according to the present invention,

FIG. 18 illustrates that the U shape handle in FIG. 17 is pulled upwards and the cover thereof is opened.

FIG. 19 shows that a camera is placed on the driving shaft of the handle shown in FIG. 18.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The structure of the present invention will be described herein with reference to the drawings.

In the present invention, a case 100 is installed with a U shape handle. The U shape handle device is capable of locating a camera. The U shape handle includes a camera locating unit for locating a camera. The camera locating unit has a driving shaft having a ball at one end thereof for combining to the U shape handle so that the driving shaft is rotatable multiple-directionally with respect to the U shape handle by using the ball as a fulcrum.

With reference to FIG. 17, it is illustrated that a U shape handle is installed to a bag. Preferably, the U shape handle 10 is telescopic. The structure of the present invention includes the following elements.

A case 100 serves for receiving objects therein. The case 100 may be a case of a packet, a bag or a trunk.

A U shape handle 10 is installed to the case 100. The U shape handle 100 is telescopically installed to the case 100.

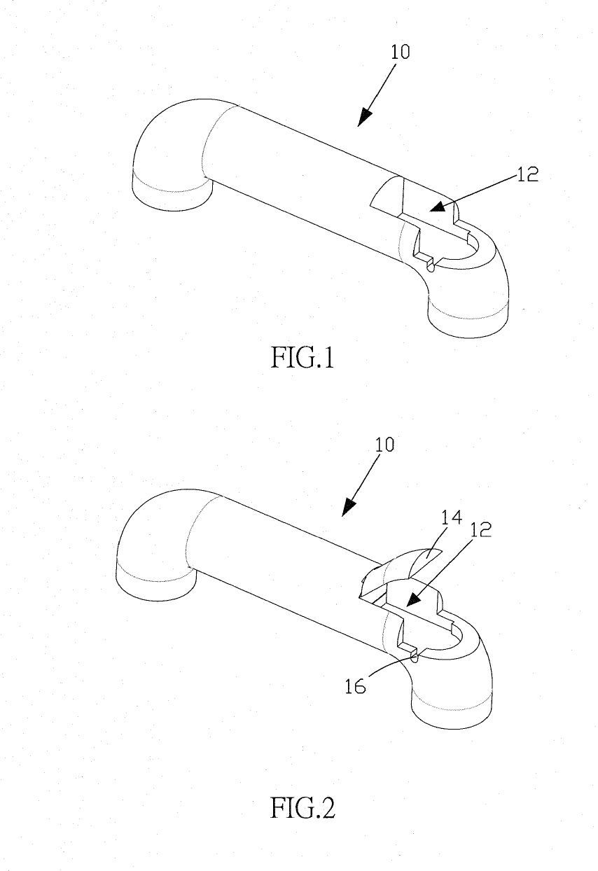

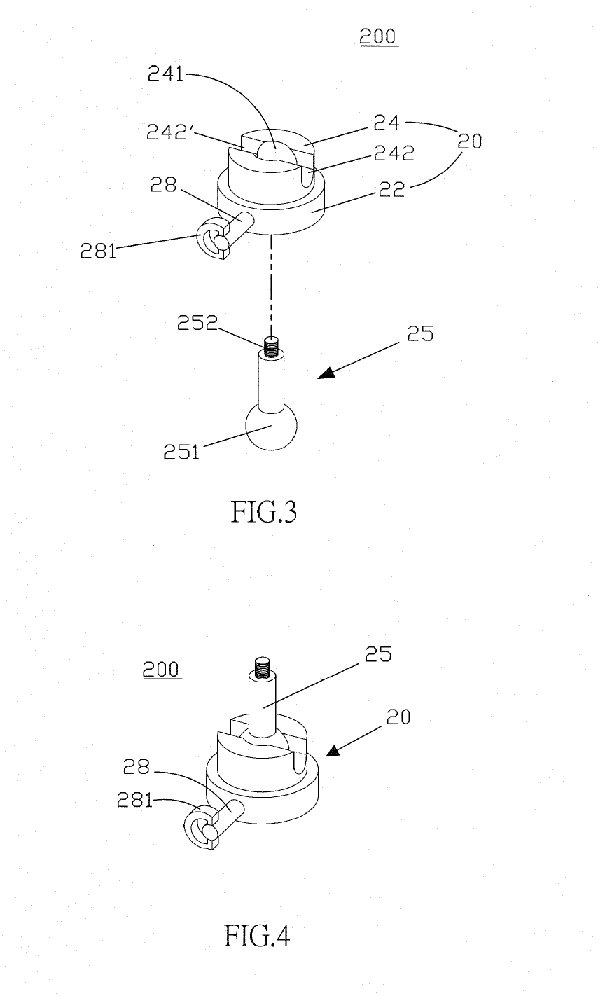

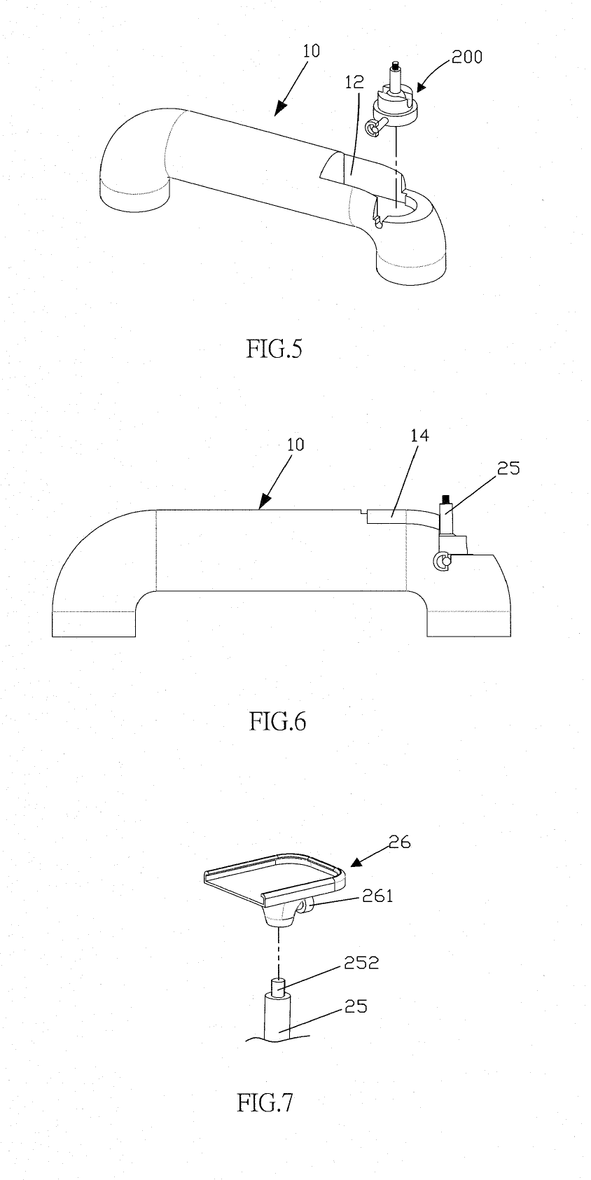

With reference to FIGS. 1 to 5, the detailed of the U shape handle capable of locating a camera is illustrated. The U shape handle of the present invention includes the following elements:

A handle has a receiving groove 12.

A camera locating unit 200 is formed at a predetermined position of the U shape handle 10, preferably within the receiving groove 12. The camera locating unit 200 is rotatable to a desire orientation so as to fix a camera located thereon to the desired orientation. Preferably, the camera locating unit 200 is shifted from a center of the handle so as not to hinder the action of a hand holding the handle. The camera locating unit 200 includes a base 20, a driving shaft 25, a platform 26 and a rotating bar 28.

The base 20 is connected to the U shape handle 10. The base 20 includes a retaining seat 22 and a movable seat 24. The movable seat 24 is installed in the retaining seat 22. The movable seat 24 is formed with at least one trench 242 and a ball locating area 241 communicated to the trench 242. The movable seat 24 is rotatably installed to the rotating bar 28. However, in the present invention, the ball locating area 241 and trenches 242, 242′ can be directly formed on the base 20. The trenches 242, 242′ are communicated to the ball locating area 241.

The driving shaft 25 has one enlarged end as a ball 251 and another end thereof is used as a connecting end 252. The ball 251 is installed in the ball locating area 241 of the base 20. The connecting end 252 serves to be connected to a camera locating platform, a quick-detaching mechanism or to be connected to a camera. Preferably, the connecting end 252 is threaded for screwing to a screw hole of a camera.

The rotating bar 28 serves to retain the ball 251 of the driving shaft 25 in the ball locating area 241 to a desired movable level.

The receiving groove 12 serves to locate the camera locating unit 200 and extends from the camera locating unit 200 for receiving the driving shaft 25. If the driving shaft 25 is not used, the driving shaft 25 can be received within the groove 12 by rotating the driving shaft 25 into the receiving groove 12.

When the camera locating unit 200 is installed in the receiving groove 12, the driving shaft 25 can also be place in the receiving groove 12.

Preferably, the camera locating unit 200 is shifted from a center of the U shape handle 10 and near an edge of the U shape handle 10 for avoiding the hand holding the handle from touching the receiving groove 12 or an object within the receiving groove 12.

As illustrated in FIG. 2, an upper side of the receiving groove 12 is installed with a cover 14 for covering whole or a part of an opening of the receiving groove 12, not only providing a beautiful outlook, but also providing a good feeling to user holding the U shape handle 10.

The receiving groove 12 has a notch 16 for locating the rotating bar 28. The notch 16 penetrates through a lateral wall of the receiving groove 12 so that the rotating bar 28 can pass through the wall of the receiving groove 12 to extend out of the U shape handle 10.

The notch 16 may have a form of a hole, however, these are not used to confine the scope of the present invention. Other forms having the same function are also permissible in the present invention.

With reference to FIG. 4, the rotating bar 28 has an acting bar 281 which has an approximate semi-round shape and is positioned on the rotating bar 28 for driving the rotating bar 28 to rotate and be locked easily.

With reference to FIG. 6, when the driving shaft 25 stands, the cover 14 can cover upon the opening of the receiving groove 12. One lateral side of the driving shaft 25 resists against the lateral edge of the cover 14 so that the driving shaft 25 will not fall into the receiving groove 12, and thus the object supported by the driving shaft 25 (in this embodiment, the object is placed upon a platform, such as a camera) will not collide with the U shape handle 10 or the wall of the receiving groove 12.

With reference to FIG. 7, the camera locating unit 200 has a platform 26 which is combined to the driving shaft 25 for locating a camera.

By the structure of the present invention, the position of the platform 26 is changeable by rotating the ball 251 of the driving shaft 25 in the ball locating area 241. If necessary, the driving shaft 25 can be embedded into the trench 242 so that the platform 26 is almost vertically arranged. The camera locating unit 200 is received in the receiving groove 12 or stands for use.

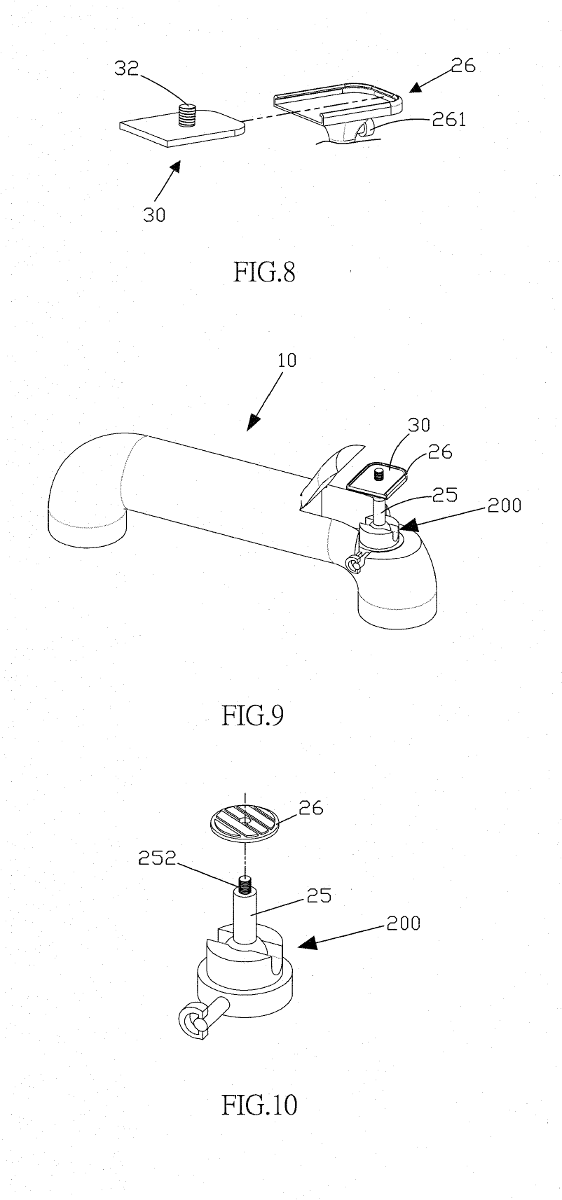

With reference to FIGS. 8 and 9, the camera locating unit 200 includes:

A retaining sheet 30 is installed with a screw 32 to be locked into a screw hole in a bottom of a camera for being connected to the camera. The retaining sheet 30 can be embedded into the platform 26. A tenon 261 serves to control the retaining sheet 30 to be locked to or released from the platform 26. When the tenon 26 is pressed, the retaining sheet 30 will leave from the platform 26 and then the retaining sheet 30 is taken out.

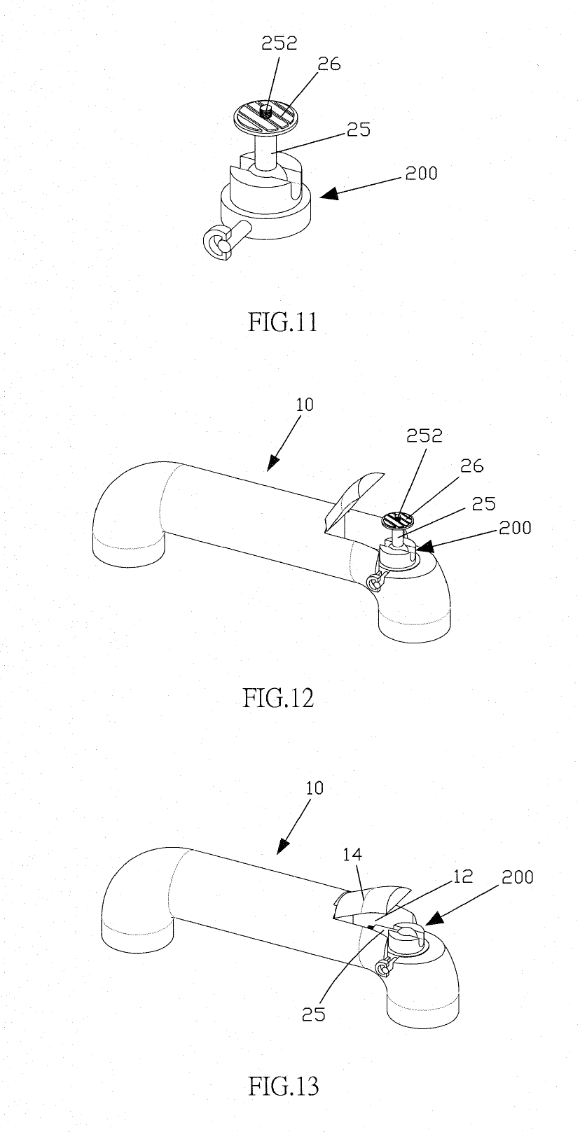

With reference to FIGS. 10 to 12, another embodiment about the platform is illustrated. In this embodiment, the platform 26 connected to the camera locating unit 200 may be formed with a screw hole. In installation, the connecting end 252 of the driving shaft 25 will pass through the screw hole of the platform 26 and then the connecting end 252 is locked to a screw hole of a camera, while the platform 26 serves to support the camera.

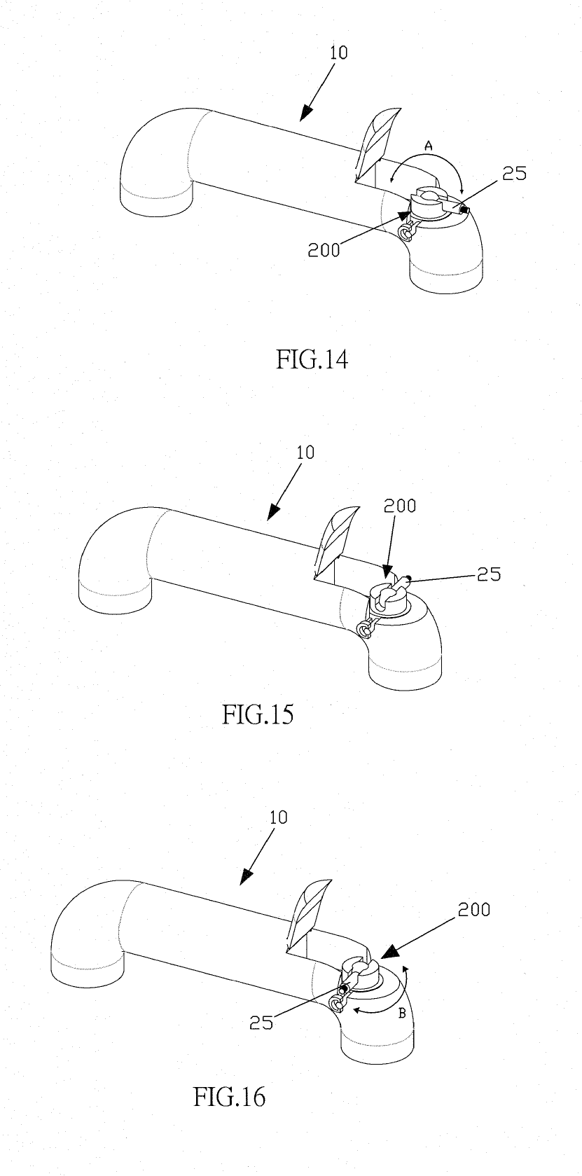

With reference to FIGS. 2, 4, 13 and 14, in the present invention, the trenches 242, 242′ of the base 20 serve to receive the driving shaft 25 in two opposite directions aside the camera locating unit 200. The driving shaft 25 can be received into the receiving groove 12 for storage, or the driving shaft 25 is placed out of the U shape handle 10 for locating the platform 26 vertically. The moving direction A in FIG. 13 serves to indicate the moving direction of the driving shaft 25.

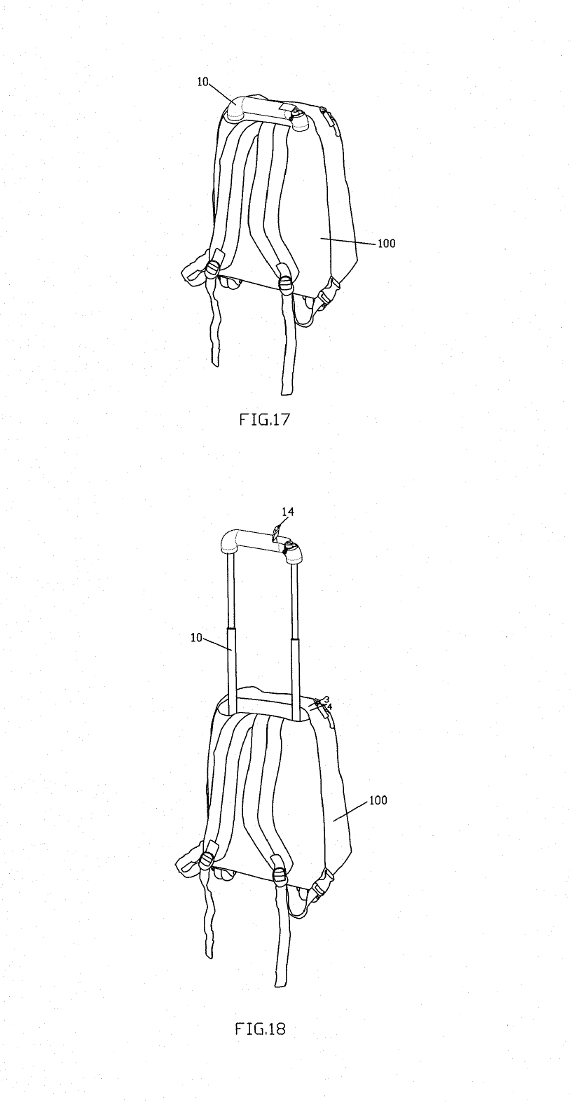

As illustrated in FIGS. 2, 4, 15 and 16, a direction B serves to indicate the moving direction of the driving shaft 25 of the driving shaft 25 with respect to a horizontal plane of the U shape handle 10.

From above description, it is known that the driving shaft 25 of the camera locating unit 200 is movable horizontally or vertically with respect to the U shape handle 10 by using the ball 251 as a fulcrum. The design of the ball locating area 241, the driving shaft 25 can rotate multiple-directionally so that the camera locating unit 200 can be positioned at different orientations for being used.

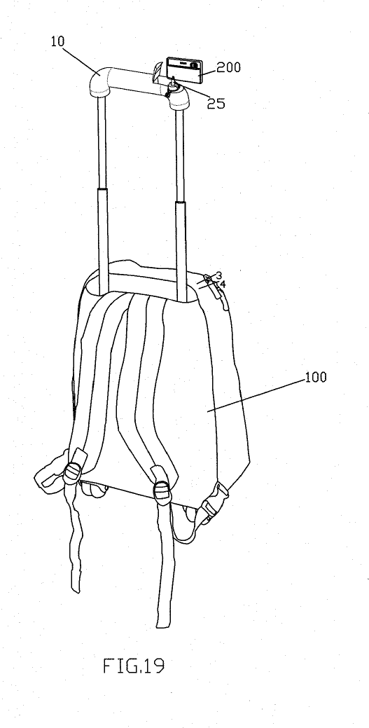

With reference to FIGS. 17, 18 and 19, it is illustrated that the U shape handle illustrated in FIGS. 1 to 16 is installed to a handle of a bag. In FIG. 17, it is illustrated that the U shape handle 10 of the present invention illustrated in above FIGS. 1 to 16 is installed to a bag 100, preferably, the U shape handle 10 is telescopic. It can be pulled out for being held by a hand or reduced into the bags 100 for storages as it is not used. In FIG. 18, it is illustrated that the U shape handle 10 is pulled upwards and the cover thereof is opened. In FIG. 19, it is illustrated that a camera 200 is placed on the driving shaft of the handle.

The present invention is mainly applied the U shape handles to various traveling bags or packsacks, etc. By the structure of the present invention, in use, the user only needs to install the platform of the camera locating unit to a specific position. Then a camera is positioned on the platform for taking pictures. No tripod is needed. Thus, in traveling, less objects are carried and all the baggage are light for the traveler.

The object of the present invention is to install a U shape handle of the present invention to a general used bags, such as travelling bags, packsacks, etc. with a function of locating a camera. Thus, in travelling or movement, no tripod is carried. In capturing pictures, it only needs to place a camera on the platform and the bag is placed to a desired location. Then the user can take pictures as desired.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A suitcase with a telescopic handle for locating a camera, comprising:
a case for locating objects;
a telescopic handle installed in the case; the handle being holdable for driving the case to move and being as a tripod; and
a camera locating unit installed in the handle for locating a camera.

2. The suitcase with a telescopic handle for locating a camera, wherein the camera locating unit is rotatable and is fixable in different aspects.

3. The suitcase with a telescopic a handle for locating a camera as claimed in claim 1, wherein the camera locating unit has a driving shaft having a ball at one end thereof for combining to the handle so that the driving shaft is rotatable multiple-directionally with respect to the handle by using the ball as a fulcrum.

4. The suitcase with a telescopic a handle for locating a camera as claimed in claim 3, wherein the camera locating unit further includes a base; the base includes a retaining seat and a movable seat;
the retaining seat being connected to the handle;
the movable seat being installed on the retaining seat; the movable seat being rotatable with respect to the retaining seat; the movable seat having a ball locating area for locating the ball at one end of the driving shaft; and
the movable seat having a trench extending from two ends of the ball locating area.

5. The suitcase with a telescopic handle for locating a camera as claimed in claim 3, wherein the camera locating unit further has a base which is connected to the handle; the base has a groove for installing the base of the driving shaft and two trenches extending from two opposite ends of the groove; and the groove serving to install the base at one end of the driving shaft.

6. The suitcase with a telescopic handle for locating a camera as claimed in claim 3, wherein the camera locating unit includes a rotating bar at a predetermined position of the camera locating unit for controlling, retaining and releasing the movement of the ball with respect to the camera locating unit.

7. The suitcase with a telescopic handle for locating a camera as claimed in claim 3, wherein the handle further includes a receiving groove adjacent to the camera locating unit for receiving the driving shaft in a predetermined position.

8. The suitcase with a telescopic handle for locating a camera as claimed in claim 7, further comprising a cover for covering a part or whole of the receiving groove.

9. The suitcase with a telescopic handle for locating a camera as claimed in claim 3, wherein another end of the driving shaft is connected to a platform for locating an object for taking picture;
a retaining sheet being engageable to the platform; the retaining sheet having a screw for locking the retaining sheet to a screwing hole at a bottom of a camera; and
a tenon extended from a lower bottom of a platform for retaining the platform to the driving shaft; when the tenon is pressed inwards, the retaining sheet is pushed away from the platform for taking the retaining sheet away from the platform.

10. The suitcase with a telescopic handle for locating a camera as claimed in claim 3, wherein another end of the driving shaft is connected to a platform for locating an object for taking picture; a lower bottom of the platform has a screw hole; and a threaded portion of the driving shaft passes through the screw hole of the platform for locking a camera or a related device.

11. The suitcase with a telescopic handle for locating a camera as claimed in claim 1, wherein the handle has a U shape.

12. The suitcase with a telescopic handle for locating a camera as claimed in claim 1, wherein the camera locating unit is shifted from a center of the handle and near an edge of the handle.

13. The suitcase with a telescopic handle for locating a camera as claimed in claim 1, wherein the suitcase is one of a bag, a packet, backbag, a trunk, luggage hole.

14. The suitcase with a telescopic handle for locating a camera as claimed in claim 1, wherein the rotating bar has an acting bar which is positioned on the rotating bar for driving the rotating bar to rotate and be locked easily.

15. The suitcase with a telescopic handle for locating a camera as claimed in claim 14, wherein he acting bar has an approximate semi-round shape and [symbol]
